(19) United States
(12) Patent Application Publication
(10) Pub. No.: US 2022/0161499 A1
(43) Pub. Date: May 26, 2022

(54) SYSTEMS AND METHODS FOR REAL-TIME OPTOELECTRONIC ASSESSMENTS OF FLUID VOLUME IN FLUID DISPENSING SYSTEMS

(71) Applicant: Cellink AB, Gothenburg (SE)

(72) Inventors: Hany AbuShall, Blacksburg, VA (US); Hector Martinez, Gothenburg (SE); Erik Gatenholm, Gothenburg (SE)

(21) Appl. No.: 17/434,321

(22) PCT Filed: Feb. 26, 2019
(86) PCT No.: PCT/US2019/019664

§ 371 Date: Aug. 26, 2021

(51) Int. Cl. B29C 64/393; G01F 11/02; G01F 23/292; G01S 17/10; B29C 64/209; B29C 64/321; B29C 64/112; B33Y 50/02; B33Y 70/00; B33Y 10/00; B33Y 30/00

(52) U.S. Cl. CPC B29C 64/393; G01F 11/027; G01F 23/2928; G01S 17/10; B29C 64/209; B33Y 30/00; B29C 64/112; B33Y 50/02; B33Y 70/00; B33Y 10/00; B29C 64/321

(57) ABSTRACT

Systems and methods for real-time optoelectronic assessments of fluid volume and other fluid properties in fluid dispensing systems are described. The systems and methods include the use of optoelectronic and software algorithms to aid in the determination of fluid volume and other fluid properties, before, during and/or after the fluid dispensing process. The systems and methods described herein allow the fluid dispensing system and its user to have a feedback of real-time data about the dispensing fluid volume and other fluid properties and hence would improve the control, speed and quality of the fluid dispensing system and its dispensed fluid.

### BACKGROUND OF THE INVENTION

### Field of the Invention

The present invention relates to the field of fluid dispensing systems for different industrial applications. The list of fluids that can be used with the invention described herein includes different types of adhesives, bait gels, braze pastes, epoxies, greases, lubricants, room temperature vulcanizing sealants, silicones, solder pastes, other assembly fluids and biomaterials. The range of applications that use such fluid dispensing systems and materials is wide and varied. For instance, such applications include fluid dispensing systems and materials that are used in the assembly, affixing, sealing, and lubrication of aerospace, automotive, construction, electronics, food manufacturing and packaging, life sciences, wireless units, devices, assemblies and equipment.

The present invention can be used for both types of dispensing systems, namely: air powered and positive displacement dispensing systems. It also can be used for low and high viscosity fluids that needs to be dispensed in a controlled way.

The present invention is used to measure accurately in real-time the fluid volume in a fluid dispensing system so that to provide for a highly controlled dispensing of those fluids. As stated above, it can be applied to a wide variety of fluids and fluid dispensing systems for a plethora of industrial applications. The ability provided by this invention to accurately measure the fluid volume in a fluid dispensing system in real-time can also be beneficial in several other ways. For instance, knowing in real-time the fluid volume in a fluid dispensing system while dispensing, the system can account for variations in temperature, pressure and fluid viscosity using physically-based mathematical models and hence will be able to display more accuracy and control in dispensing fluids. In addition, it will provide the fluid dispensing system with the ability to predict the temperature, pressure, fluid flow rate and viscosity at the dispensing end (e.g. nozzle) and at the point of application of the fluid for any of the applications and uses stated in this document.

In principle, the present invention can be directly installed on different fluid dispensing systems without a need to alter those systems either electronically or mechanically. The real-time fluid volume measuring unit can be easily mounted on the fluid barrel adapter side of the dispensing system fluid barrel allowing for air power and/or positive displacement input to function normally. The real-time fluid volume measuring unit uses electronic and optoelectronic components to perform its function. It is adequately small enough in size to fit into many current fluid dispensing systems.

### Description of Related Art

A fluid dispensing system is a device, machine or equipment that is responsible for dispensing a fluid in controlled quantities and apply it on a desired area. Being able to precisely dispense fluids onto a specific point in a controlled way is a main characteristic of precision fluid dispensing systems.

Precision fluid dispensing systems can use either air pressure or positive displacement to dispense fluids in a controlled way. Air powered fluid dispensing system use air pressure that is outputted by a pump or a similar device and push on a piston or piston-like component that in turn push a fluid in a barrel out of the nozzle. Positive displacement fluid dispensing systems on the other hand do not use compressed air. They usually push a piston inside a barrel by means of a mechanical force that can be generated by electric stepper motors. They are ideal for instance for two-part epoxies and fluids that change viscosity over time generally.

Precision fluid dispensing systems can be manually or automatically operated. They can be used in small volume and mass production applications.

Precision fluid dispensing systems are used in various applications that demand accurate, uniform, process-controlled, and high throughput of repeatable deposits. Examples for such applications are mentioned in the following points.

Precision fluid dispensing systems are used in the life sciences in applications such as diagnostic equipment, hearing aids, pacemakers, respiration devices and surgical and dental tools.

Precision fluid dispensing systems are used in electronics in applications such as surface-mount boards, digital cameras, liquid crystal displays, computer board assemblies, micro-speakers and microwave components.

Precision fluid dispensing systems are used in the automotive industry in applications such as engine components, electrical systems, brakes, body and instrument panels, frames, transmissions and wheels.

Precision fluid dispensing systems are used in the aerospace industry in applications such as turbines, propellant parts, measurement instruments, GPS systems, electrical systems and cockpits.

Examples for fluids that are used in precision fluid dispensing systems include solder pastes, thermal compounds, silicones, sealants, adhesives, epoxies, greases and lubricants.

### SUMMARY OF THE INVENTION

Embodiments of the present invention provide systems and methods for real-time optoelectronic assessments of fluid volume in fluid dispensing systems. The systems and methods include the use of optoelectronic and software algorithms to aid in the determination of fluid volume and other fluid properties, before, during and/or after the fluid dispensing process. The systems and methods described herein allow the fluid dispensing system and its user to have a feedback of real-time data about the dispensing fluid volume and other fluid properties and hence would improve the control, speed and quality of the fluid dispensing system and its dispensed fluid.

Additional embodiments and their features will be elaborated in the foregoing Detailed Description and Aspects of the invention.

Aspect 1 is a fluid dispensing system comprising: a. one or more distance ranging apparatus; b. one or more processing element capable of processing the data coming from the distance ranging apparatus; c. one or more non-transitory computer-readable storage media comprising: i. one or more process algorithms capable of quantifying one or more fluid properties based on the data gathered by the distance ranging apparatus and other available sources of information; and ii. one or more learning algorithms capable of modifying and adjusting the fluid dispensing system parameters based on one or more fluid properties; d. one or more control element; e. one or more communication interface elements operably connecting and capable of communicating distance ranging data and the information driven from it among the one or more distance ranging apparatus, one or more processing element, one or more control element and one or more non-transitory computer-readable storage media.

Aspect 2 is the fluid dispensing system of Aspect 1, wherein the one or more fluid properties are chosen from one or more of fluid volume, mass, weight, flow rate, density, viscosity, temperature, pressure, specific volume, specific weight and/or specific gravity.

Aspect 3 is the fluid dispensing system of any preceding Aspect, wherein the one or more sources of information are chosen from one or more of the fluid dispensing system user, one or more of processing element generated data, one or more analog sensors and/or one or more digital sensors.

Aspect 4 is the fluid dispensing system of any preceding Aspect, wherein the one or more distance ranging apparatus are fixed or detachable.

Aspect 5 is the fluid dispensing system of any preceding Aspect, wherein the one or more distance ranging apparatus are chosen from one or more of optical ranging apparatus, one or more of laser ranging apparatus, one or more of ultrasonic ranging apparatus, one or more of radar ranging apparatus, one or more of sonar ranging apparatus and/or one or more LIDAR ranging apparatus.

Aspect 6 is the fluid dispensing system of any preceding Aspect, wherein the one or more processing element are chosen from one or more of hardware processing element, one or more of software processing element, one or more of systems processing element, one or more of computer processing element, one or more of central processing unit, one or more of microprocessor application-specific instruction set processor, one or more of physics processing unit, one or more of digital signal processor, one or more of image processor, one or more of coprocessor, one or more of floating-point unit, one or more of network processor, one or more multi-core processor, one or more of front-end processor, one or more information processor, one or more data processing system and/or one or more information system.

Aspect 7 is the fluid dispensing system of any preceding Aspect, wherein the one or more non-transitory computer-readable storage media are chosen from one or more of computer memory, one or more RAM, one or more magnetic storage media, one or more of optical storage media, one or more of nonvolatile memory storage media, one or more of volatile memory, one or more of floppy disks, one or more of magnetic tape, one or more of conventional hard disks, one or more of CD-ROM, one or more of DVD-ROM, one or more of BLU-RAY, one or more of Flash ROM, one or more of memory cards, one or more of optical drives, one or more of solid state drives, one or more of flash drives, one or more of erasable programmable read only memory, one or more of electrically erasable programmable read-only memory and/or one or more of non-volatile ROM.

Aspect 8 is the fluid dispensing system of any preceding Aspect, wherein the one or more non-transitory computer-readable storage media include one or more sets of computer-executable instructions for providing an operating system as well as for implementing the algorithms and methods of the invention.

Aspect 9 is the fluid dispensing system of any preceding Aspect, wherein the one or more sets of computer-executable instructions are programmed from one or more of any suitable programming languages including JavaScript, C, C#, C++, Java, Python, Perl, Ruby, Swift, Visual Basic, and Objective C.

Aspect 10 is the fluid dispensing system of any preceding aspect, comprising one or more additional components chosen from one or more motors, one or more dispensing syringes, one or more dispensing fluids, one or more dispensing barrels, one or more dispensing fluid containers, one or more platforms, one or more operating controls, one or more power cables, one or more USB cables, one or more communication cables and/or one or more data cables.

Aspect 11 is the fluid dispensing system of any preceding Aspect, wherein the one or more distance ranging apparatus and/or one or more processing element are in communication with or integrated with one or more databases.

Aspect 12 is the fluid dispensing system of any preceding Aspect, wherein the one or more distance ranging apparatus and/or one or more processing element are in communication with or integrated with one or more databases for storing one or more dispensing fluid properties.

Aspect 13 is the fluid dispensing system of any preceding Aspect, wherein the one or more distance ranging apparatus and/or one or more processing element are in communication with or integrated with one or more databases for storing one or more dispensing fluid properties, which one or more dispensing fluid properties are capable of being shared and compared across batches and users.

Aspect 14 is the fluid dispensing system of any preceding Aspect, wherein the one or more distance ranging apparatus comprise one or more infrared, one or more near-infrared, one or more visible, and/or one or more UV light source.

Aspect 15 is the fluid dispensing system of any preceding Aspect, wherein the one or more distance ranging apparatus comprise one or more LASER, one or more light emitting diode light source, one or more incandescence light source, one or more aventurescence light source, one or more bioluminescence light source, one or more cathodoluminescence light source, one or more chemiluminescence light source, one or more cryoluminescence light source, one or more crystalloluminescence light source, one or more electrochemiluminescence light source, one or more electroluminescence light source, one or more mechanoluminescence light source, one or more photoluminescence light source, one or more radioluminescence light source and/or one or more thermoluminescence light source.

Aspect 16 is the fluid dispensing system of any preceding Aspect, wherein the one or more control element are chosen from one or more of microcontroller, one or more system on a chip, one or more computer, one or more processor unit, one or more central processing unit and/or one or more embedded controller unit.

Aspect 17 is the fluid dispensing system of any preceding Aspect, wherein one or more air pressure and/or one or more positive displacement mechanisms can be used to dispense the dispensing fluid.

Aspect 18 is the fluid dispensing system of any preceding Aspect, which can be operated manually and/or automatically.

Aspect 19 is the fluid dispensing system of any preceding Aspect, which can be utilized for home use, small volume production and/or mass production setting.

Aspect 20 is the fluid dispensing system of any preceding Aspect, wherein the one or more dispensing fluids used are chosen from one or more adhesives, one or more bait gels, one or more braze pastes, one or more epoxies, one or more greases, one or more lubricants, one or more room temperature vulcanizing sealants, one or more silicones, one or more solder pastes and/or one or more thermal compounds.

Aspect 21 is the fluid dispensing system of any preceding Aspect, which can be utilized in the aerospace industry, wherein the one or more dispensing fluids are used in propellant parts, satellites, seating, cockpits, electrical systems, flight recorders, global positioning systems, instrument panels, landing gear, measurement instruments, military munitions, turbines and/or wire harnesses.

Aspect 22 is the fluid dispensing system of any preceding Aspect, which can be utilized in the wireless industry, wherein the one or more dispensing fluids are used in touch panels, protective treatments, miscellaneous unit assemblies, micro-speakers, keypads, frames, displays, cover glasses, camera modules, and/or accessories.

Aspect 23 is the fluid dispensing system of any preceding Aspect, which can be utilized in the life sciences, wherein the one or more dispensing fluids are used in vial filling, syringe lubrication, surgical and dental tools, stent coating, respiration devices, pills and medicines, pace-makers, membranes, hearing aids, diagnostic equipment, defibrillators, contact lenses and/or catheters.

Aspect 24 is the fluid dispensing system of any preceding Aspect, which can be utilized in the food manufacturing and packaging, wherein the one or more dispensing fluids are used in shrink wrapping, lubricating foil slitters, lubricating can stock, lubricating can ends, filling foil packets and other containers, coating food with scent/flavoring and/or filling perfume bottles.

Aspect 25 is the fluid dispensing system of any preceding Aspect, which can be utilized in the electronics industry, wherein the one or more dispensing fluids are used in surface mounted printed circuit boards, computer board assemblies, microwave components, membrane switches, liquid crystal displays, light emitting diodes, fiber optics, electronic housing chassis, electronic chips, digital cameras and/or capacitors.

Aspect 26 is the fluid dispensing system of any preceding Aspect, which can be utilized in construction, wherein the one or more dispensing fluids are used in roof installation, nail plate manufacturing, joint sealing, hydraulic pumps, door and window sealing, crack repair, chemical anchors into concrete, brick, stone and wood and/or caulking.

Aspect 27 is the fluid dispensing system of any preceding Aspect, which can be utilized in the automotive industry, wherein the one or more dispensing fluids are used in wiring harness connectors, windshields, wheels, transmissions, regulators, sensors, relays, passenger restraints, mirrors, lighting, headlamps, instrument panels, fuel systems, frames and suspensions, engine components, electrical systems, control switches, brakes, body panels and/or air conditioning systems.

Aspect 28 is the fluid dispensing system of any preceding Aspect, which can be utilized in 3D printers and/or 3D bioprinters for dispensing fluids, hydrogels, bioinks, cell-laden bioinks, polymeric biomaterials such as, but not limited to, Polymethyl methacrylate (PMMA) bone cement, PDMS, Vulcanite, Celluloid, Phenolformaldehyde, Polyvinylchloride, PLA, PLGA, biocompatible ceramics, and biocompatible composites such as, but not limited to, dimethacrylate (Bis-GMA), urethane di methacrylate oligomers (UDMA) and triethylene glycol dimethacrylate (TEGDMA).

Aspect 29 is the fluid dispensing system of any preceding Aspect, which can be utilized in 3D printers and/or 3D bioprinters for dispensing one or more fluids and/or one or more bioinks can use a non-transitory computer-readable storage media comprising one or more process algorithms capable of quantifying printing characteristics chosen from one or more of shape, uniformity, thickness, size, and/or color of a deposited structure from one or more images and/or video of a first printed structure produced by the 3D printer or bioprinter.

Aspect 30 is the fluid dispensing system of any preceding Aspect, which can be utilized in 3D printers and/or 3D bioprinters for dispensing one or more fluids and/or one or more bioinks can use a non-transitory computer-readable storage media comprising one or more learning algorithms capable of modifying and adjusting printing instructions and/or printing parameters based on one or more fluid properties to achieve a second printed structure.

Aspect 31 is the fluid dispensing system of any preceding Aspect, which can be utilized in 3D printers and/or 3D bioprinters for dispensing one or more fluids and/or one or more bioinks, wherein the printing parameters are chosen from one or more of applied pressure, strain, force, or flow, printhead translation rate, bioink temperature, bioink composition, print surface temperature, layer height, infill pattern and density, nozzle diameter, nozzle shape, and/or nozzle material.

Aspect 32 is the fluid dispensing system of any preceding Aspect, which can be utilized in 3D printers and/or 3D bioprinters for dispensing one or more fluids and/or one or more bioinks, wherein the extruded one or more fluids and/or one or more extruded bioinks form one or more droplet, one or more printed filament, one or more 3D geometric structure and/or one or more multilayered structure.

### BRIEF DESCRIPTION OF THE DRAWINGS

FIG. 1 is a schematic drawing of an air powered fluid dispensing system according to embodiments of the invention.

FIG. 2 is a schematic drawing of a positive displacement fluid dispensing system according to embodiments of the invention.

FIG. 3 is a schematic drawing of a fluid volume measurement in an air powered fluid dispensing system according to embodiments of the invention.

FIG. 4 is a schematic drawing of a fluid volume measurement in an air powered fluid dispensing system showing the rangefinder sensor according to embodiments of the invention.

FIG. 5 is a schematic drawing of a fluid volume measurement in a positive displacement fluid dispensing system according to embodiments of the invention.

FIG. 6 is a schematic drawing of an air powered fluid dispensing system showing its operation according to embodiments of the invention.

FIG. 7 is a schematic drawing of a positive displacement fluid dispensing system showing its operation according to embodiments of the invention.

FIG. 8 is a flowchart of steps for an exemplary process according to the invention.

FIG. 9 is a schematic drawing of an air powered fluid dispensing system attached to 3D bioprinter printhead for real-time bioink volume measurement according to embodiments of the invention.

FIG. 10 is a schematic drawing of an air powered fluid dispensing system attached to 3D bioprinter printhead for real-time bioink volume measurement showing a typical operation of it according to embodiments of the invention.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

Definitions:

The following definitions are provided to facilitate understanding of certain terms provided in this specification. For other terms not defined herein, the ordinary meaning as recognized by an ordinarily-skilled artisan should be applied.

Fluid Dispensing System: Fluid dispensing systems include all types of devices, systems and equipment that dispense, mix and dispense, or mix, meter, and dispense fluid media. In addition, it includes precise systems that accurately dispense media in a controlled and repetitive manner controlled by processing and/or controlling elements. The range of applications that use such fluid dispensing systems and materials is wide and varied. For instance, such applications include fluid dispensing systems and materials that are used in the assembly, affixing, sealing, and lubrication of aerospace, automotive, construction, electronics, food manufacturing and packaging, life sciences, wireless units, devices, assemblies and equipment.

Distance Ranging Apparatus: Distance ranging devices include all types of equipment that can measure the distance of a target from itself based on time of flight or other calculation mechanism. Methods of measurement include optical ranging devices, laser ranging devices, ultrasonic ranging devices, radar ranging devices, sonar ranging devices and LIDAR ranging devices.

Processing Element: A processing element is an electronic circuitry or an integrated circuit within a computer or an electronic system that carries out the instructions of a computer program by performing the basic arithmetic, logical, control and input/output (I/0) operations specified by the instructions. Microprocessors mean they are contained on a single integrated circuit (IC) chip. An IC that contains a CPU may also contain memory, peripheral interfaces, and other components of a computer; such integrated devices are variously called microcontrollers or systems on a chip (SoC). Some systems employ a multi-core processor, which is a single chip containing two or more processing units called “cores”.

Non-Transitory Computer-Readable Storage Media: Non-transitory computer-readable storage media are electronic circuitry, computer components, devices and/or recording media that are used to retain digital and/or analog data for further processing and/or referencing purposes. Examples for storage media include computer memory, random access memory (RAM), magnetic storage media, optical storage media, nonvolatile memory storage media, volatile memory, floppy disks, magnetic tape, conventional hard disks, CD-ROM, DVD-ROM, BLU-RAY, Flash ROM, memory cards, optical drives, solid state drives, flash drives, erasable programmable read only memory, electrically erasable programmable read-only memory and/or non-volatile ROM.

Process Algorithm: A process algorithm is any algorithm or protocol that receives data from the distance ranging apparatus and identifies points of interest in the data, isolates them, and quantifies various fluid properties in the fluid dispensing system.

Learning Algorithm: A learning algorithm is any algorithm that receives data from or during a measurement and utilizes data from a broader dataset to automatically improve the existing fluid dispensing system in terms of accuracy, control and/or speed.

Fluid Properties: Fluid properties determine how they can be used in the respective field and technology. They also determine their behavior and mechanics. Examples for some of the basic properties of fluids are fluid volume, mass, weight, flow rate, density, viscosity, temperature, pressure, specific volume, specific weight and specific gravity.

Control Element: The control element can comprise an analog circuitry and/or digital units in order for it to control the function of a system. An example for a digital controller is a microcontroller chip. A microcontroller contains one or more CPUs (processor cores) along with memory and programmable input/output peripherals. Microcontrollers are used in automatically controlled products and devices, such as automobile engine control systems, implantable medical devices, remote controls, office machines, appliances, power tools, toys and other embedded systems. Other examples for control elements include proportional-integral-derivative (PID) controller, system on a chip, computer, processor unit, central processing unit and embedded controller unit.

Communication Interface Element: Communication interface elements operably connect and communicate data and information between different devices and units. For instance, in the invention described herein these elements can communicate the distance ranging data and the information driven from it among the distance ranging devices, processing elements, control elements and non-transitory computer-readable storage media.

LIDAR Ranging Apparatus: Lidar is a method that measures distance to a target by illuminating the target with pulsed laser light and measuring the reflected pulses with a sensor. Differences in laser return times and wavelengths can then be used to make digital 3-D representations of the target. Lidar sometimes is called laser scanning and 3-D scanning.

Air Powered Fluid Dispensing System: An air powered fluid dispensing system is a fluid dispensing system that uses air pressure that is outputted by a pump or a similar device and push on a piston or piston-like component that in turn push a fluid in a barrel out of the nozzle.

Positive Displacement Fluid Dispensing System: A positive displacement fluid dispensing system is a fluid dispensing system that pushes a piston inside a barrel by means of a mechanical force that can be generated by electric stepper motors. They are ideal for instance for two-part epoxies and fluids that change viscosity over time generally.

Precision Fluid Dispensing System: Precision fluid dispensing systems are fluid dispensing systems that are capable of precisely dispensing fluids onto a specific point in a controlled way.

3D Printer: A 3D printer is a computer-aided manufacturing (CAM) device that is capable of creating three-dimensional objects. 3D printers use a process called additive manufacturing to make 3D physical objects layer by layer until the model is complete. Examples for technologies used for 3D printing include stereolithography (SLA) and fused deposit modeling (FDM).

3D Bioprinter: A 3D bioprinter utilizes 3D printing and 3D printing-like techniques to combine cells, growth factors, and biomaterials to fabricate biomedical parts that maximally imitate natural tissue characteristics. Generally, 3D bioprinting utilizes the layer-by-layer method to deposit materials known as bioinks to create tissue-like structures that are later used in medical and tissue engineering fields. Bioprinting covers a broad range of biomaterials. Currently, bioprinting can be used to print tissues and organs to help research drugs and pills.

Printhead: A printhead is a unit that is capable of releasing and/or dispensing printing material onto the printbed in order to make droplets, filaments and/or 3D multi-layered structures in a controlled and precise way.

Bioink: Bioinks are mostly fluid materials that can be dispensed by printheads to be deposited on a printbed to build layer-by-layer 3D structures. They provide appropriate environment for cell growth and can be used to create tissue-like structures that are later used in the medical and tissue engineering fields.

Printing Parameters of Bioinks: Printing parameters of bioinks include applied pressure, strain, force, or flow, translation rate of the printhead during the printing process, temperature of the bioink, temperature of the print surface, layer height, infill pattern and density, the nozzle diameter, nozzle shape, and nozzle material.

Droplet: A droplet is a structure that is formed when an ink, for example, a bioink, is extruded at a single location on the print surface. The printhead does not translate in the x-y plane (where the x-y plane is the print surface), only in the z-direction, if necessary. Depending on the composition of the bioink, the resultant shape is typically circular or eclipse in shape when observed from above with an eccentricity between 0 and 1, and a minimum volume of 1 μL.

Printed Filament: A printed filament is a structure that is formed when a bioink is extruded across the print surface where the printhead translates along waypoints to result in a non-enclosed structure. The printhead translates in the x-y plane (where the x-y plane is the print surface), with the nozzle positioned above the surface in the z-axis at a height between 10% and 500% of the nozzle inner diameter. A printed filament structure typically has a minimum total length to width ratio of 1 and a maximum of 500.

Geometric Structure: A geometric structure is a structure that is formed when a bioink is extruded across the print surface during printhead translation along waypoints and intersects or contacts the existing structure to enclose an area. The printhead translates in the x-y plane (where the x-y plane is the print surface), with the nozzle positioned above the surface in the z-axis at a height between 10% and 500% of the nozzle inner diameter. These geometric structures have a minimum of 0 vertices and 1 edge and enclose an area. The angle between subsequent edges at vertices can range from 1 degree to 179 degrees.

Multilayered Structure: A multilayered structure is a structure that is generated when a bioink is extruded on top of a previously deposited structure. The printhead translates in the x-y plane (where the x-y plane is the previously deposited structure), with the nozzle positioned above the previously deposited structure in the z-axis at a height between 10% and 500% of the nozzle inner diameter. Droplets, printed filaments, geometric shapes, and infill patterns can all be printed on the previously printed layer. The number of previously printed layers is a minimum of 1 to achieve the maximum build height set by the bioprinter system being utilized.

Infill Pattern: An infill pattern is a structure that is formed when a bioink is extruded across a print surface during printhead translation along waypoints in a fashion to fill in a printed geometric shape. The printhead translates in the x-y plane (where the x-y plane is the print surface), with the nozzle positioned above the surface in the z-axis at a height between 10% and 500% of the nozzle inner diameter. The infill pattern typically provides structural support, porosity, or generates micro-architectures that mimic native tissue structure or serve as a framework for tissue regeneration. The spacing between the center of adjacent filaments (x-y positioning on the print surface) can range from a distance equal to the filament diameter to 5 times or 10 times the filament diameter. For example, for a 150 μm filament, the spacing between the center of adjacent filaments can be 150 μm, up to 0.75 mm, up to 1.5 mm. Infill pattern can also include subsequently smaller volumes encapsulated by a geometric shape. Deposited filaments such as those composed of sacrificial materials such as PEO, PEG, pluronics, and/or gelatin based bioink, can be used. Sacrificial materials which dissolve or are otherwise not permanent or present in the final structure are useful, for example, for creating void regions, conduits, and/or perfusable channels and can also be considered an infill pattern. These sacrificial materials may comprise 0% to 100% of the infill pattern, such as from 5-90%, or 15-75%, or 30-60%, or 10-80%, or 20-50%, for example.

Embodiments of the present invention provide systems and methods for real-time optoelectronic assessments of fluid volume in fluid dispensing systems. In one embodiment, a fluid dispensing system is provided that includes a plurality of components that work in concert to opto-electronically characterize one or more fluid properties of the fluid dispensing system.

Provided is a fluid dispensing system comprising one or more of the following:
a. one or more distance ranging apparatus;
b. one or more processing element capable of processing the data coming from the distance ranging apparatus;
c. one or more non-transitory computer-readable storage media comprising:
i. one or more process algorithms capable of quantifying one or more fluid properties based on the data gathered by the distance ranging apparatus and other available sources of information; and
ii. one or more learning algorithms capable of modifying and adjusting the fluid dispensing system parameters based on one or more fluid properties;
d. one or more control element;
e. one or more communication interface elements operably connecting and capable of communicating distance ranging data and the information driven from it among the one or more distance ranging apparatus, one or more processing element, one or more control element and one or more non-transitory computer-readable storage media.

According to embodiments, the fluid dispensing system described can calculate for any one or more of the fluid properties of the dispensing fluid such as fluid volume, mass, weight, flow rate, density, viscosity, temperature, pressure, specific volume, specific weight and/or specific gravity.

According to embodiments, the fluid dispensing system described can have one or more sources of information to aid achieving its goals. Examples include the fluid dispensing system user, one or more of processing element generated data, one or more analog sensors and/or one or more digital sensors.

According to embodiments, the fluid dispensing system described can have one or more fixed or detachable distance ranging devices. In addition, the one or more distance ranging apparatus can be chosen from one or more optical ranging apparatus, laser ranging apparatus, ultrasonic ranging apparatus, radar ranging apparatus, sonar ranging apparatus and/or LIDAR ranging apparatus. In addition, the one or more distance ranging apparatus can comprise one or more infrared, near-infrared, visible, and/or UV light sources. Moreover, the one or more distance ranging apparatus can comprise one or more LASER, light emitting diode, incandescence, aventurescence, bioluminescence, cathodoluminescence, chemiluminescence, cryoluminescence, crystalloluminescence, electrochemiluminescence, electroluminescence, mechanoluminescence, photoluminescence, radioluminescence and/or thermoluminescence light sources.

According to embodiments, the fluid dispensing system described can have its one or more processing element be chosen from one or more hardware processing element, software processing element, systems processing element, computer processing element, central processing unit, microprocessor application-specific instruction set processor, physics processing unit, digital signal processor, image processor, coprocessor, floating-point unit, network processor, multi-core processor, front-end processor, information processor, data processing system and/or information system.

According to embodiments, the fluid dispensing system described can have its one or more non-transitory computer-readable storage media be chosen from one or more computer memory, RAM, magnetic storage media, optical storage media, nonvolatile memory storage media, volatile memory, floppy disks, magnetic tape, conventional hard disks, CD-ROM, DVD-ROM, BLU-RAY, Flash ROM, memory cards, optical drives, solid state drives, flash drives, erasable programmable read only memory, electrically erasable programmable read-only memory and/or non-volatile ROM.

According to embodiments, the fluid dispensing system described can have one or more non-transitory computer-readable storage media that include computer-executable instructions for providing an operating system as well as for implementing the algorithms and methods of the invention. The one or more sets of computer-executable instructions are programmed from one or more of any suitable programming languages including JavaScript, C, C#, C++, Java, Python, Perl, Ruby, Swift, Visual Basic, and Objective C.

According to embodiments, the fluid dispensing system described can include in addition one or more additional components chosen from motors, dispensing syringes, dispensing fluids, dispensing barrels, dispensing fluid containers, platforms, operating controls, power cables, USB cables, communication cables and/or data cables.

According to embodiments, the fluid dispensing system described can have one or more distance ranging apparatus and/or one or more processing element that are in communication with or integrated with one or more databases for storing one or more dispensing fluid properties, which one or more dispensing fluid properties are capable of being shared and compared across batches and users.

According to embodiments, the fluid dispensing system described can have one or more control elements that can be chosen from one or more microcontroller, system on a chip, computer, processor unit, central processing unit and/or embedded controller unit.

According to embodiments, the fluid dispensing system described can use one or more air pressure and/or one or more positive displacement mechanisms to dispense the dispensing fluid. In addition, it can be operated manually and/or automatically. Moreover, it can be utilized for home use, small volume production and/or mass production setting.

According to embodiments, the fluid dispensing system described can use one or more dispensing fluids that can be chosen from one or more adhesives, bait gels, braze pastes, epoxies, greases, lubricants, room temperature vulcanizing sealants, silicones, solder pastes and/or thermal compounds.

According to embodiments, the fluid dispensing system described can be utilized in the aerospace industry, in which the one or more dispensing fluids can be used in propellant parts, satellites, seating, cockpits, electrical systems, flight recorders, global positioning systems, instrument panels, landing gear, measurement instruments, military munitions, turbines and/or wire harnesses.

According to embodiments, the fluid dispensing system described can be utilized in the wireless industry, in which the one or more dispensing fluids can be used in touch panels, protective treatments, miscellaneous unit assemblies, micro-speakers, keypads, frames, displays, cover glasses, camera modules, and/or accessories.

According to embodiments, the fluid dispensing system described can be utilized in the life sciences, in which the one or more dispensing fluids can be used in vial filling, syringe lubrication, surgical and dental tools, stent coating, respiration devices, pills and medicines, pace-makers, membranes, hearing aids, diagnostic equipment, defibrillators, contact lenses and/or catheters.

According to embodiments, the fluid dispensing system described can be utilized in the food manufacturing and packaging, in which the one or more dispensing fluids can be used in shrink wrapping, lubricating foil slitters, lubricating can stock, lubricating can ends, filling foil packets and other containers, coating food with scent/flavoring and/or filling perfume bottles.

According to embodiments, the fluid dispensing system described can be utilized in the electronics industry, in which the one or more dispensing fluids can be used in surface mounted printed circuit boards, computer board assemblies, microwave components, membrane switches, liquid crystal displays, light emitting diodes, fiber optics, electronic housing chassis, electronic chips, digital cameras and/or capacitors.

According to embodiments, the fluid dispensing system described can be utilized in construction, in which the one or more dispensing fluids can be used in roof installation, nail plate manufacturing, joint sealing, hydraulic pumps, door and window sealing, crack repair, chemical anchors into concrete, brick, stone and wood and/or caulking.

According to embodiments, the fluid dispensing system described can be utilized in the automotive industry, in which the one or more dispensing fluids can be used in wiring harness connectors, windshields, wheels, transmissions, regulators, sensors, relays, passenger restraints, mirrors, lighting, headlamps, instrument panels, fuel systems, frames and suspensions, engine components, electrical systems, control switches, brakes, body panels and/or air conditioning systems.

According to embodiments, the fluid dispensing system described can be utilized in 3D printers and/or 3D bioprinters for dispensing fluids, bioinks and biomaterials.

According to embodiments, the fluid dispensing system described when used in 3D printers/bioprinters for dispensing one or more fluids/bioinks can use a non-transitory computer-readable storage media comprising one or more process algorithms capable of quantifying printing characteristics chosen from one or more of shape, uniformity, thickness, size, and/or color of a deposited structure from one or more images and/or video of a first printed structure produced by the 3D printer/bioprinter.

According to embodiments, the fluid dispensing system described when used in 3D printers/bioprinters for dispensing one or more fluids/bioinks can use a non-transitory computer-readable storage media comprising one or more learning algorithms capable of modifying and adjusting printing instructions and/or printing parameters based on one or more fluid properties to achieve a second printed structure.

According to embodiments, the fluid dispensing system described when used in 3D printers/bioprinters for dispensing one or more fluids/bioinks, the printing parameters can be chosen from one or more of applied pressure, strain, force, flow, printhead translation rate, bioink temperature, bioink composition, print surface temperature, layer height, infill pattern and density, nozzle diameter, nozzle shape, and/or nozzle material.

According to embodiments, the fluid dispensing system described when used in 3D printers/bioprinters for dispensing one or more fluids/bioinks, the extruded one or more fluids/bioinks can form one or more droplet, printed filament, 3D geometric structure and/or multilayered structure.

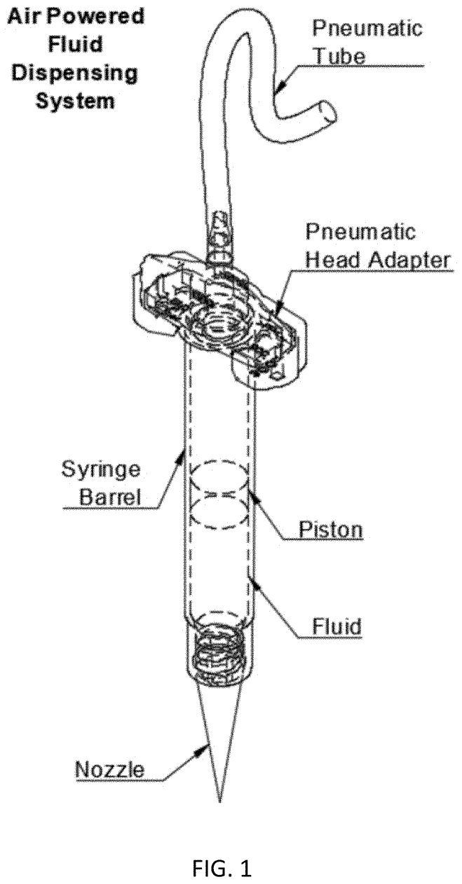

According to embodiments, as shown in FIG. 1, the fluid dispensing system can be of the air powered type in which air pressure is used to dispense the fluid. As illustrated in FIG. 1, a pneumatic tube can be coupled into the syringe barrel using a pneumatic head adapter. Air pressure pushes the piston in the syringe barrel which in turn can dispense the fluid out the nozzle.

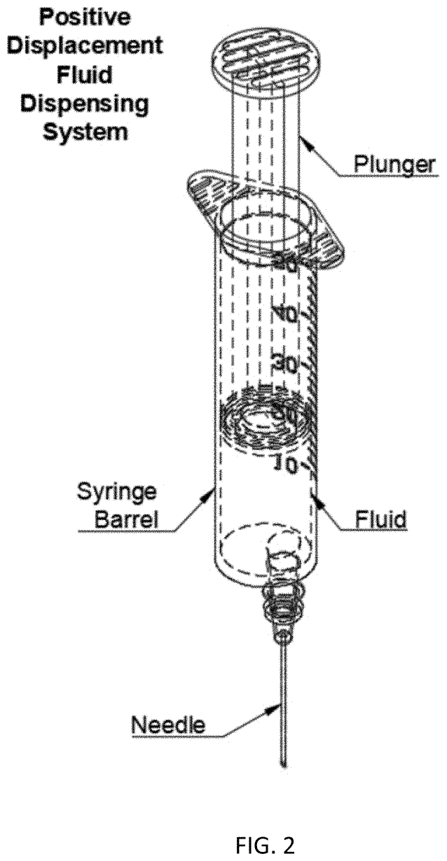

According to embodiments, as shown in FIG. 2, the fluid dispensing system can be of the positive displacement type in which the plunger can be pushed by the means of mechanical power to dispense the fluid. As illustrated in FIG. 2, the plunger helps dispensing the fluid out the needle.

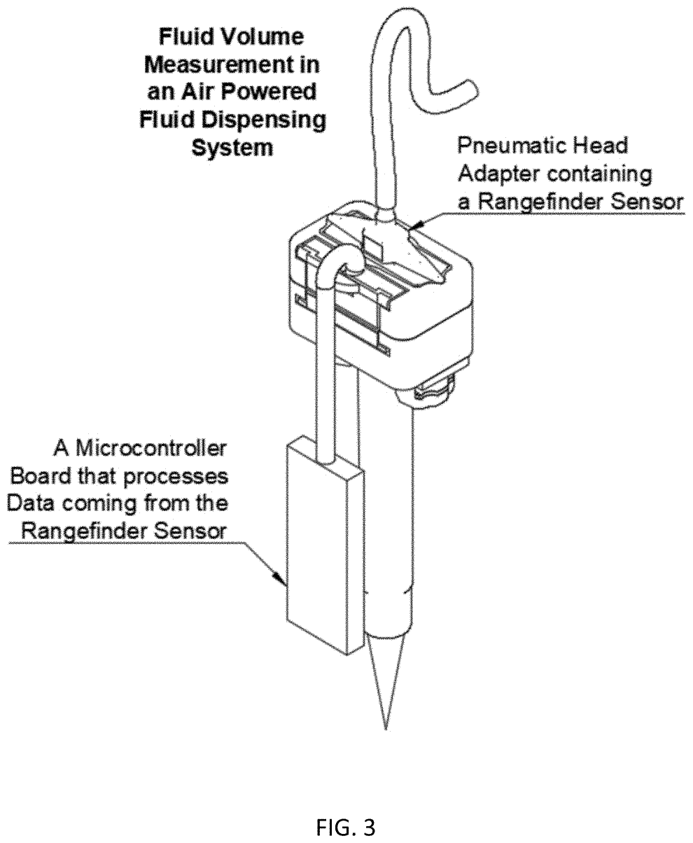

According to embodiments, as shown in FIG. 3, a rangefinder can determine the distance to the piston and based on it using a processing element such as a microcontroller, fluid volume inside the syringe barrel and other fluid properties can be determined. In the figure, the pneumatic head adapter containing the rangefinder sensor couples the pneumatic tube to the syringe barrel.

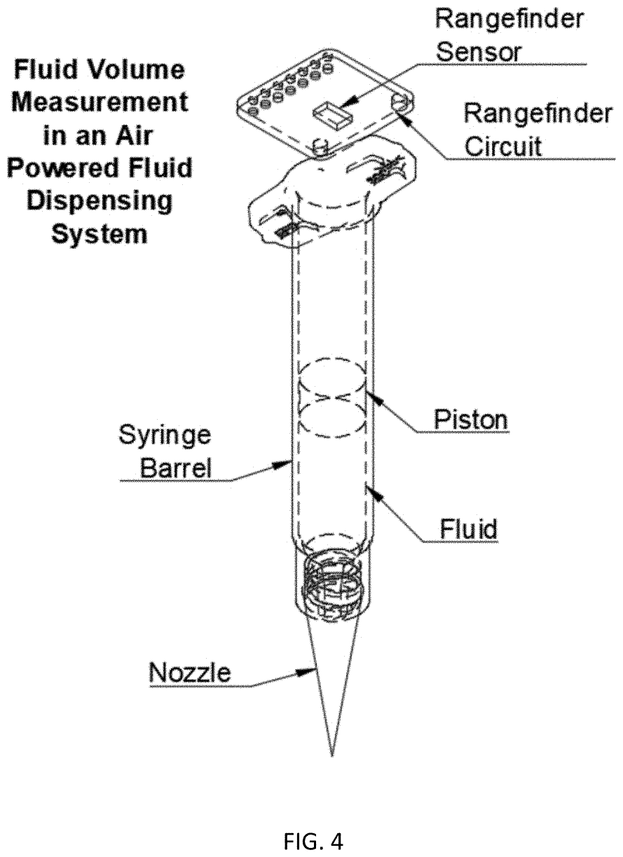

According to embodiments, as shown in FIG. 4, the rangefinder sensor needs to be at a point above the piston so that to determine the distance to it. Based on that distance, fluid volume inside the syringe barrel and other fluid properties can be calculated using a processing element. FIG. 4 shows the rangefinder sensor and its circuitry without the encasing of the head adapter.

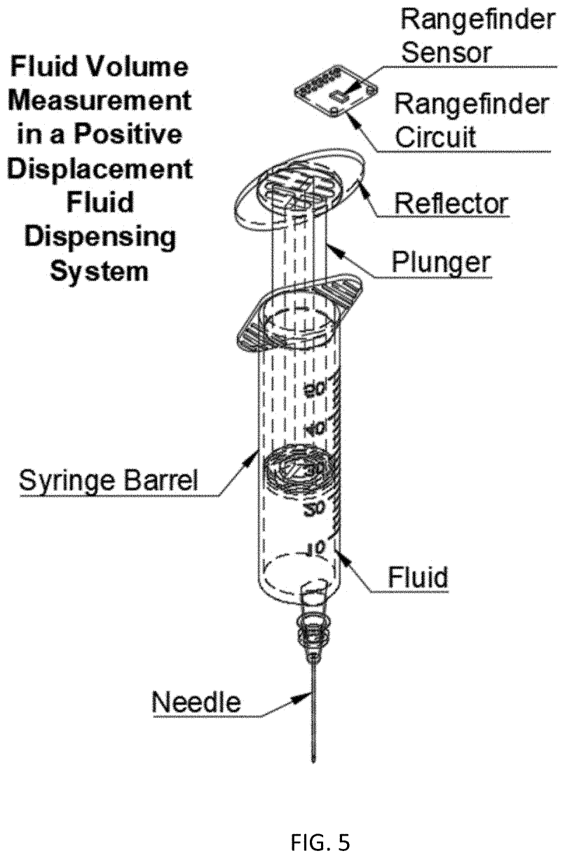

According to embodiments, as shown in FIG. 5, the rangefinder sensor needs to be at a point above the reflector surface attached to the mechanical plunger. As the plunger moves, the reflector moves along with it and the distance measured using the rangefinder sensor changes. Based on the determined distance, the volume of the fluid present inside the syringe can be calculated along with other fluid properties.

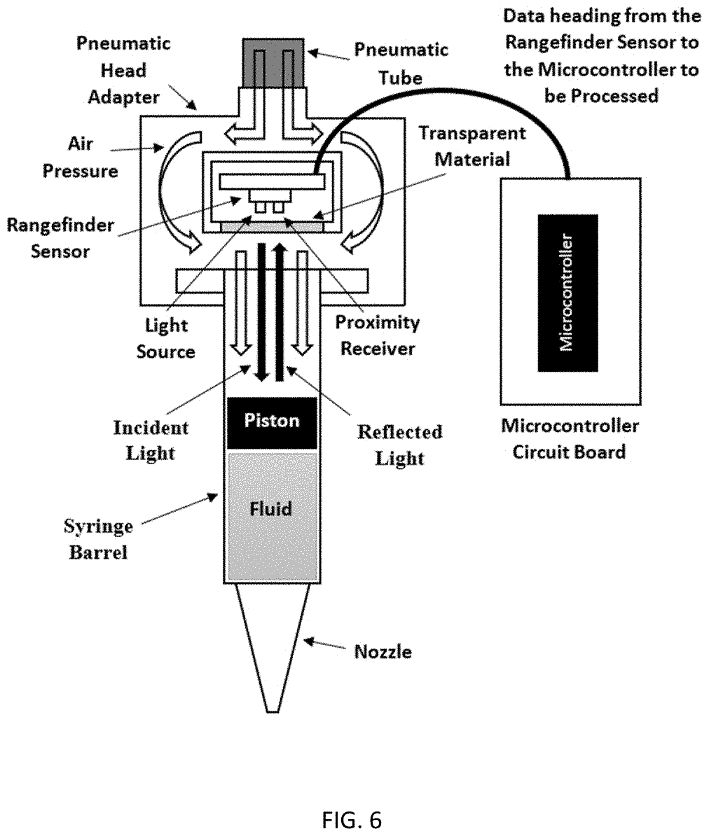

According to embodiments, as shown in FIG. 6, the rangefinder sends a laser light pulse onto the piston or a reflector on the back of the piston. The laser light pulse reflects from the piston or a reflector on its back to fall onto the proximity sensor. The rangefinder then determines the distance between itself and the piston based on the laser light pulse time of flight. This information is sent to a processing element that calculates a number of fluid properties such as fluid volume, mass, weight, flow rate, density, viscosity, temperature, pressure, specific volume, specific weight and specific gravity. Based on these information and calculations, further actions can be taken by a controlling element as a part of the fluid dispensing system in order to provide for more control, precision and speed for the system.

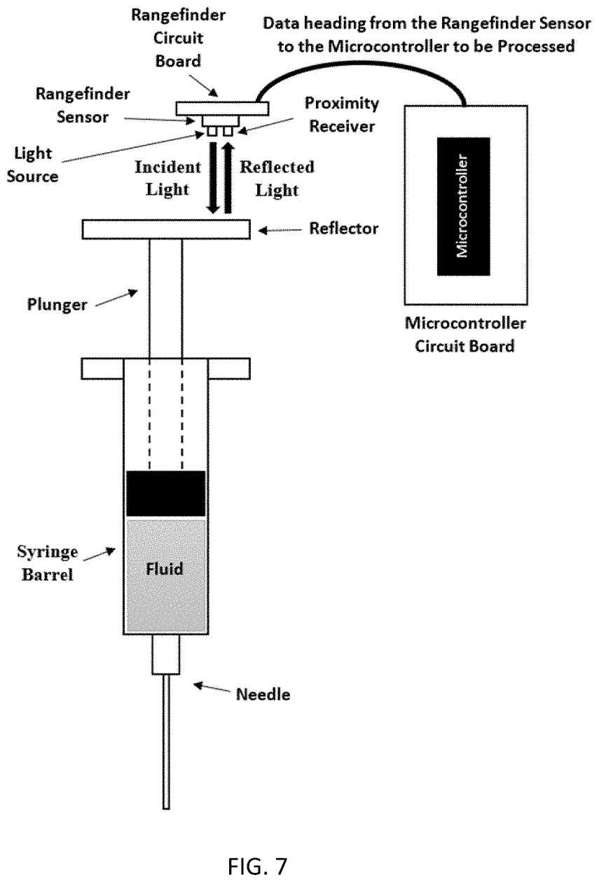

According to embodiments, as shown in FIG. 7, the rangefinder sends a laser light pulse onto the reflector attached to syringe plunger. The laser light pulse reflects from the reflector to fall onto the proximity sensor. The rangefinder then determines the distance between itself and the piston based on the laser light pulse time of flight. This information is sent to a processing element that calculates a number of fluid properties such as fluid volume, mass, weight, flow rate, density, viscosity, temperature, pressure, specific volume, specific weight and specific gravity. Based on these information and calculations, further actions can be taken by a controlling element as a part of the fluid dispensing system in order to provide for more control, precision and speed for the system.

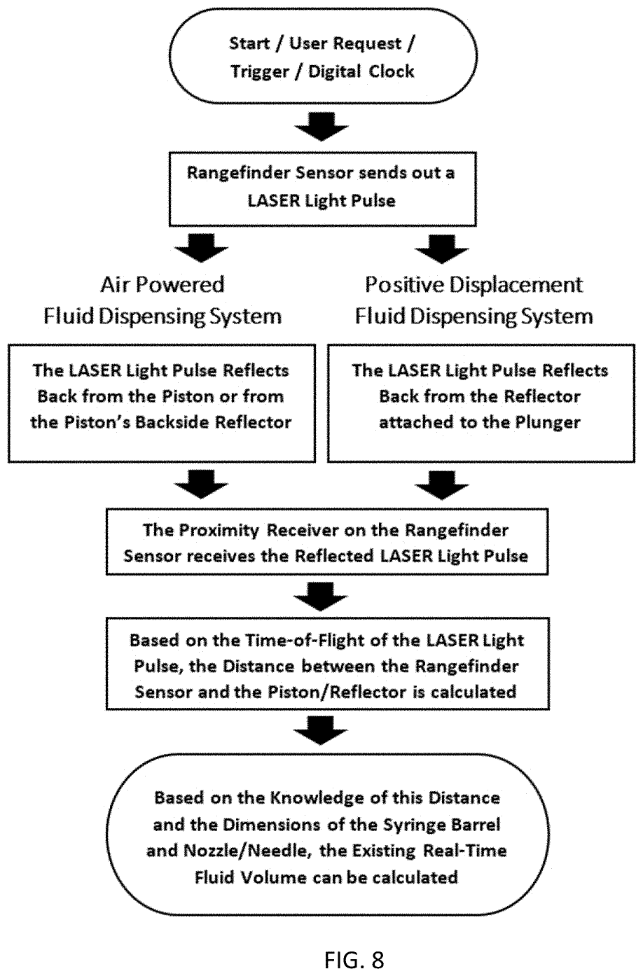

According to embodiments, as shown in FIG. 8, based on a user request, trigger and/or a digital clock, the rangefinder sensor sends out a LASER light pulse. For both types of the fluid dispensing system described here, namely an air powered and positive displacement fluid dispensing system types, the LASER light pulse reflects back from the reflector attached either to the piston or to the plunger. Next, the proximity receiver on the rangefinder sensor receives the reflected LASER light pulse. Next, based on the Time-of-Flight of the LASER light pulse, the distance between the rangefinder sensor and the piston/reflector is calculated. Finally, based on the knowledge of this distance and the dimensions of the syringe barrel and nozzle/needle, the existing real-time fluid volume can be calculated.

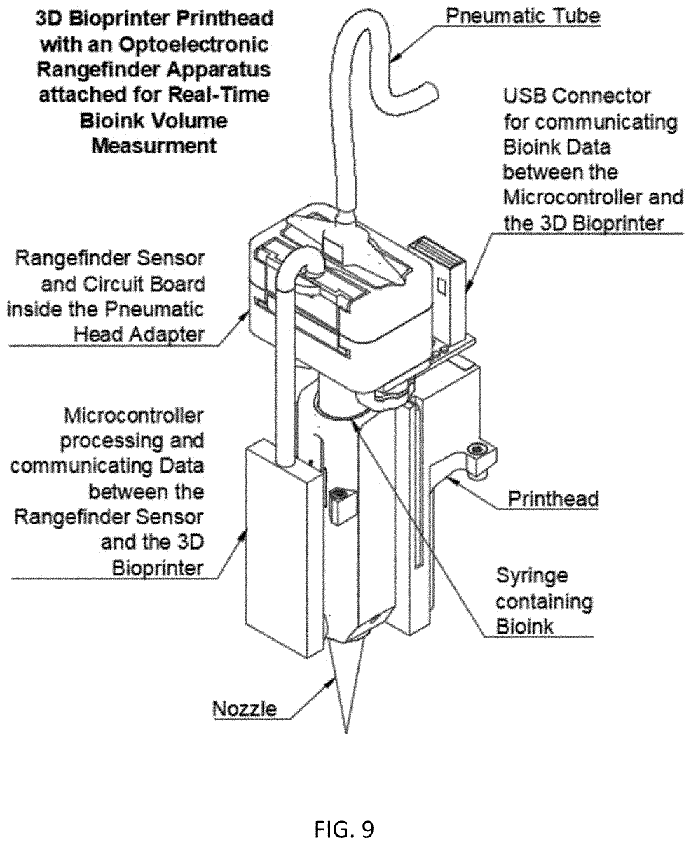

According to embodiments, as shown in FIG. 9, the fluid dispensing system described here can be part of a 3D printer/bioprinter. For instance, it can be mounted on a printhead to print droplets, filaments of different shapes and/or 3D multilayered structures of any geometry. The optoelectronic rangefinder apparatus would be attached in that case for instance for real-time bioink volume measurement or for the determination of one or more fluid properties of the fluid being dispensed by the syringe barrel. The fluid properties data can then be sent to one or more controlling elements present on either the printhead or on the 3D printer/bioprinter to change one or more of the printing parameters such as applied pressure, strain, force, flow, printhead translation rate, bioink temperature, bioink composition, print surface temperature, layer height, infill pattern and density, nozzle diameter, nozzle shape, and/or nozzle material in order to make the 3D printing process faster, more accurate and/or more reliable.

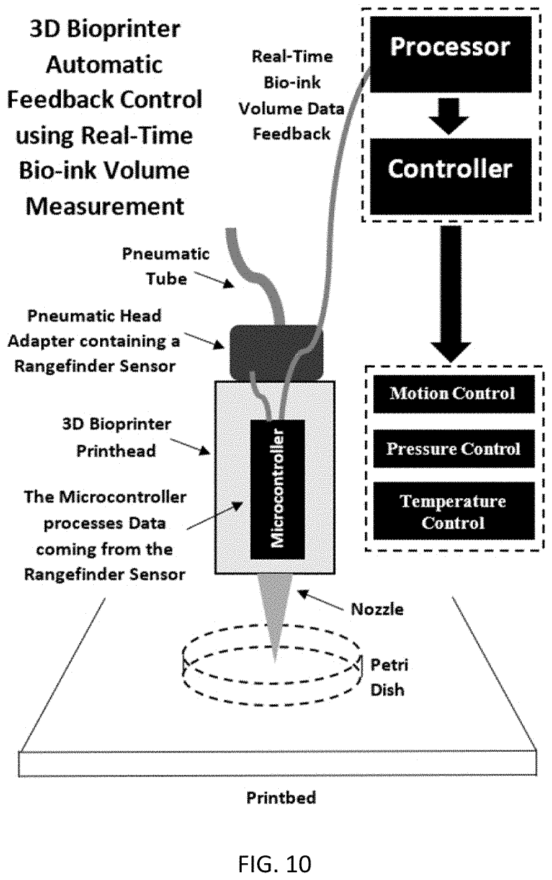

According to embodiments, as shown in FIG. 10, the fluid dispensing system mounted on a printhead for 3D printing/bioprinting communicates back data collected from the rangefinder sensor to a processing element which if needed can communicate it in turn to a controlling element that would change one or more of the printing parameters such as controlling the motion, pressure and/or temperature in a feedback mechanism in order to make the 3D printing process faster, more accurate and/or more reliable.

### EXAMPLES

An example for the fluid volume measurement of the current invention as an air powered fluid dispensing system may include the following steps. As shown in FIG. 6, the rangefinder sends a laser light pulse onto the piston or a reflector on the back of the piston. The laser light pulse reflects from the piston or a reflector on its back to fall onto the proximity sensor. The rangefinder then determines the distance between itself and the piston based on the laser light pulse time of flight. This information is sent to a processing element that calculates the fluid volume inside the syringe barrel. Based on these information and calculations, further actions can be taken by a controlling element as a part of the fluid dispensing system in order to provide for more control, precision and speed for the system.

An example for the fluid volume measurement of the current invention as a positive displacement fluid dispensing system may include the following steps. As shown in FIG. 7, the rangefinder sends a laser light pulse onto the reflector attached to syringe plunger. The laser light pulse reflects from the reflector to fall onto the proximity sensor. The rangefinder then determines the distance between itself and the piston based on the laser light pulse time of flight. This information is sent to a processing element that calculates the fluid volume inside the syringe barrel. Based on these information and calculations, further actions can be taken by a controlling element as a part of the fluid dispensing system in order to provide for more control, precision and speed for the system.

An example for the fluid/bioink volume measurement of the current invention as part of a 3D printer/bioprinter, the system may include the following parts and steps. As shown in FIG. 9 and FIG. 10, the fluid/bioink dispensing system for instance can be mounted on a printhead to print droplets, filaments of different shapes and/or 3D multilayered structures of any geometry. The optoelectronic rangefinder apparatus would be attached in that case for instance for real-time bioink volume measurement or for the determination of one or more fluid properties of the fluid being dispensed by the syringe barrel. The fluid properties data can then be sent to one or more controlling elements present on either the printhead or on the 3D printer/bioprinter to change one or more of the printing parameters such as applied pressure, strain, force, flow, printhead translation rate, bioink temperature, bioink composition, print surface temperature, layer height, infill pattern and density, nozzle diameter, nozzle shape, and/or nozzle material in order to make the 3D printing process faster, more accurate and/or more reliable.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the systems or devices disclosed herein or with any other systems or devices. Likewise, any of the disclosed systems or devices can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A fluid dispensing system comprising:
a. one or more distance ranging apparatus;
b. one or more processing element capable of processing the data coming from the distance ranging apparatus;
c. one or more non-transitory computer-readable storage media comprising:
i. one or more process algorithms capable of quantifying one or more fluid properties based on the data gathered by the distance ranging apparatus and other available sources of information; and
ii. one or more learning algorithms capable of modifying and adjusting the fluid dispensing system parameters based on one or more fluid properties;
d. one or more control element;
e. one or more communication interface elements operably connecting and capable of communicating distance ranging data and the information driven from it among the one or more distance ranging apparatus, one or more processing element, one or more control element and one or more non-transitory computer-readable storage media.

2. The fluid dispensing system of claim 1, wherein the one or more fluid properties are chosen from one or more of fluid volume, mass, weight, flow rate, density, viscosity, temperature, pressure, specific volume, specific weight and/or specific gravity.

3. The fluid dispensing system of claim 1, wherein the one or more sources of information are chosen from one or more of the fluid dispensing system user, one or more of processing element generated data, one or more analog sensors and/or one or more digital sensors.

4. (canceled)

5. The fluid dispensing system of claim 1, wherein the one or more distance ranging apparatus are chosen from one or more of optical ranging apparatus, one or more of laser ranging apparatus, one or more of ultrasonic ranging apparatus, one or more of radar ranging apparatus, one or more of sonar ranging apparatus and/or one or more LIDAR ranging apparatus.

6. The fluid dispensing system of claim 1, wherein the one or more processing element are chosen from one or more of hardware processing element, one or more of software processing element, one or more of systems processing element, one or more of computer processing element, one or more of central processing unit, one or more of microprocessor application-specific instruction set processor, one or more of physics processing unit, one or more of digital signal processor, one or more of image processor, one or more of coprocessor, one or more of floating-point unit, one or more of network processor, one or more multi-core processor, one or more of front-end processor, one or more information processor, one or more data processing system and/or one or more information system.

7. (canceled)

8. The fluid dispensing system of claim 1, wherein the one or more non-transitory computer-readable storage media include one or more sets of computer-executable instructions for providing an operating system as well as for implementing the algorithms and methods of the invention.

9. The fluid dispensing system of claim 8, wherein the one or more sets of computer-executable instructions are programmed from one or more of any suitable programming languages including JavaScript, C, C#, C++, Java, Python, Perl, Ruby, Swift, Visual Basic, and Objective C.

10. The fluid dispensing system of claim 1, comprising one or more additional components chosen from one or more motors, one or more dispensing syringes, one or more dispensing fluids, one or more dispensing barrels, one or more dispensing fluid containers, one or more platforms, one or more operating controls, one or more power cables, one or more USB cables, one or more communication cables and/or one or more data cables.

11. The fluid dispensing system of claim 1, wherein the one or more distance ranging apparatus and/or one or more processing element are in communication with or integrated with one or more databases.

12. The fluid dispensing system of claim 1, wherein the one or more distance ranging apparatus and/or one or more processing element are in communication with or integrated with one or more databases for storing one or more dispensing fluid properties.

13. The fluid dispensing system of claim 1, wherein the one or more distance ranging apparatus and/or one or more processing element are in communication with or integrated with one or more databases for storing one or more dispensing fluid properties, which one or more dispensing fluid properties are capable of being shared and compared across batches and users.

14. The fluid dispensing system of claim 1, wherein the one or more distance ranging apparatus comprise one or more infrared, one or more near-infrared, one or more visible, and/or one or more UV light source.

15. The fluid dispensing system of claim 1, wherein the one or more distance ranging apparatus comprise one or more LASER, one or more light emitting diode light source, one or more incandescence light source, one or more aventurescence light source, one or more bioluminescence light source, one or more cathodoluminescence light source, one or more chemiluminescence light source, one or more cryoluminescence light source, one or more crystalloluminescence light source, one or more electrochemiluminescence light source, one or more electroluminescence light source, one or more mechanoluminescence light source, one or more photoluminescence light source, one or more radioluminescence light source and/or one or more thermoluminescence light source.

16. The fluid dispensing system of claim 1, wherein the one or more control element are chosen from one or more of microcontroller, one or more system on a chip, one or more computer, one or more processor unit, one or more central processing unit and/or one or more embedded controller unit.

17. The fluid dispensing system of claim 1, wherein one or more air pressure and/or one or more positive displacement mechanisms can be used to dispense the dispensing fluid.

18. The fluid dispensing system of claim 1, wherein the system can be operated manually and/or automatically.

19. The fluid dispensing system of claim 1, wherein the system can be utilized for home use, small volume production and/or mass production setting.

20. The fluid dispensing system of claim 10, wherein the one or more dispensing fluids are chosen from one or more adhesives, one or more bait gels, one or more braze pastes, one or more epoxies, one or more greases, one or more lubricants, one or more room temperature vulcanizing sealants, one or more silicones, one or more solder pastes and/or one or more thermal compounds.

21-32. (canceled)

33. A method of 3D bioprinting comprising:
determining one or more desired printing characteristic chosen from one or more of shape, uniformity, thickness, size, and/or color of a deposited structure from one or more images and/or video of a first printed structure produced by a 3D printer or bioprinter;
dispensing one or more bioink according to one or more printing parameters to achieve the desired printing characteristic;
modifying and/or adjusting printing instructions and/or printing parameters based on one or more fluid properties to produce a desired 3D bioprinted structure;
wherein the dispensing is performed using a fluid dispensing system comprising:
a. one or more distance ranging apparatus;
b. one or more processing element capable of processing the data coming from the distance ranging apparatus;
c. one or more non-transitory computer-readable storage media comprising:
i. one or more process algorithms capable of quantifying one or more fluid properties based on the data gathered by the distance ranging apparatus and other available sources of information; and
ii. one or more learning algorithms capable of modifying and adjusting the fluid dispensing system parameters based on one or more fluid properties;
d. one or more control element; and
e. one or more communication interface elements operably connecting and capable of communicating distance ranging data and the information driven from it among the one or more distance ranging apparatus, one or more processing element, one or more control element and one or more non-transitory computer-readable storage media.

34. The method of claim 33, wherein the printing parameters are chosen from one or more of applied pressure, strain, force, or flow, printhead translation rate, bioink temperature, bioink composition, print surface temperature, layer height, infill pattern and density, nozzle diameter, nozzle shape, and/or nozzle material.
